(19) United States
(12) Patent Application Publication
(10) Pub. No.: US 2012/0016747 A1
(43) Pub. Date: Jan. 19, 2012

(54) System and Method of Delivering Advertising Messages from a Shop Window to a Stop-by Potential Customer

(76) Inventor: Yang Pan, Singapore (SG)

(21) Appl. No.: 12/838,434

(22) Filed: Jul. 17, 2010

(51) Int. Cl. G06Q 30/00; G06K 9/00

(52) U.S. Cl. 705/14.64; 382/100

(57) ABSTRACT

A system for delivering advertising messages from a shop window to a stop-by potential customer is disclosed. An image capturing system including multiple digital cameras is employed to determine orientation of the person towards at least one of displayed items. Advertising messages related to the displayed item are transmitted to a mobile device carried by the person.

### CROSS-REFERENCE TO RELATED APPLICATIONS

Not applicable.

### BACKGROUND

1. Field of Invention

This invention relates generally to advertising. More specifically, the invention relates to system and method for delivering advertising messages to a stop-by potential customer of a display area such as a shop window.

2. Description of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device. It has always been a significant challenge to understand the user's real interests and to deliver the advertising message accordingly.

### SUMMARY

It is an object of the present invention to disclose a system and method for delivering advertising messages to a mobile device carried by a person stopping by a window shop.

It is a further object of the present invention to disclose a method that determines facial orientation of the person towards one of the displayed items and therefore advertising messages related to the item can be delivered accordingly.

In accordance with one embodiment of the present invention, the advertising message delivery system comprises an electronic sub-system installed in the shop window and a mobile communication device carried by the potential customer. When the person stops by a shop window in exceeding of a predetermined period of time, an ad hoc communication link is established between the electronic sub-system and the mobile device.

Multiple image capturing devices are used to determine the facial orientation of the person towards one of displayed items. Advertising messages related to the displayed items are delivered to the mobile device. According to one implementation, the image capturing devices may be installed along a frame of the shop window. According to another implementation, each displayed item may be associated with one or more image capture devices.

In accordance with another embodiment of the present invention, both the electronic sub-system and the mobile device are connected to a public communication network. The electronic sub-system receives a communication address such as a phone number from the mobile device after they are connected in an ad hoc manner. The advertising messages are delivered to the mobile device through the public communication network.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1A is a schematic diagram of a window shop advertising message delivery system in accordance with one embodiment that image capture devices are installed along the frame of the shop window;

FIG. 1B is a schematic diagram of the window shop advertising message delivery system in accordance with another embodiment that image capture devices are installed in association with the displayed items;

FIG. 2A is a schematic diagram of functional blocks of the advertising message delivery system in accordance with one embodiment;

FIG. 2B is a schematic diagram of functional blocks of the advertising message delivery system in accordance with another embodiment;

FIG. 3 is a schematic diagram illustrating that a received message from an electronic sub-system is displayed on a display screen of the mobile communication device;

FIG. 4A is a flowchart illustrating a process that an advertising message is delivered from the shop window to the mobile communication device through an ad hoc communication link in accordance with one embodiment;

FIG. 4B is a flowchart illustrating a process that an advertising message is delivered from the shop window to the mobile communication device through an ad hoc communication link in accordance with another embodiment;

FIG. 5 is a flowchart illustrating a process that an advertising message is delivered from the shop window to the mobile communication device in accordance with the embodiment that a public communication network is utilized;

FIG. 6 is a schematic diagram of an extension of the present inventive concept to a generic display area in a shop.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

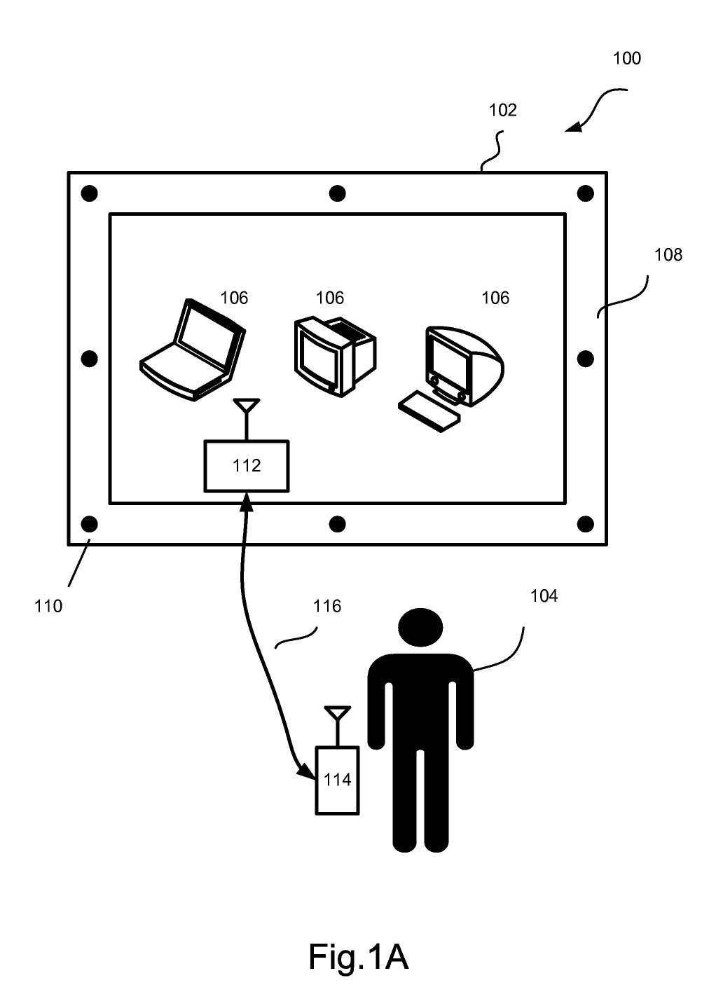

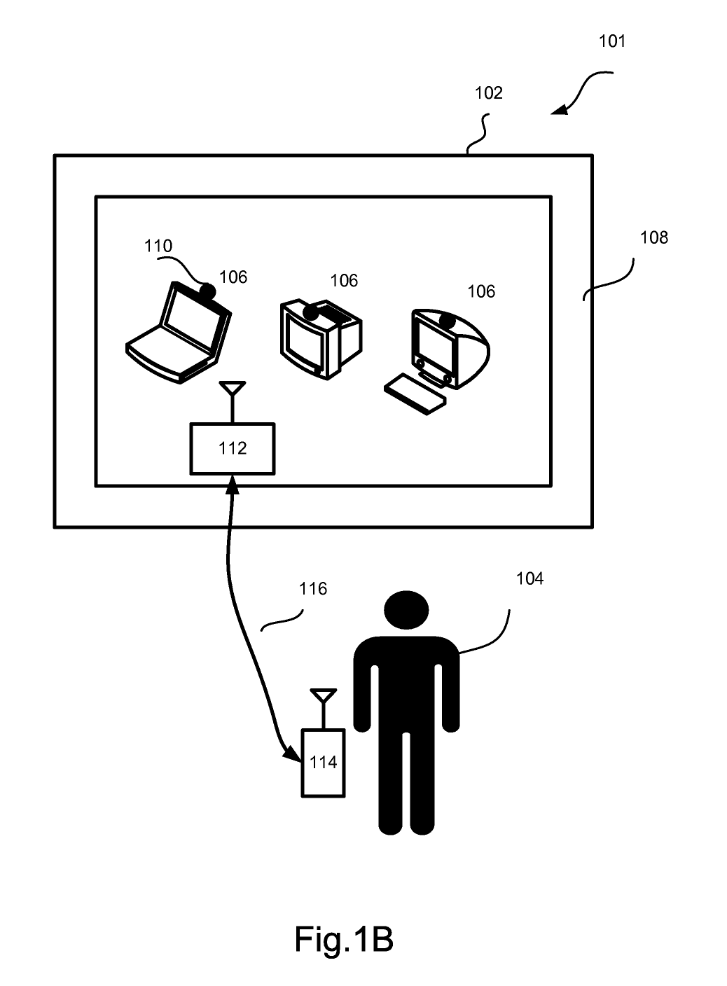

FIG. 1A is a schematic diagram illustrating an advertising message delivery system according to one embodiment. The system 100 comprises a shop window 102 and a potential customer 104. The shop window 102 includes multiple displayed items 106 as illustrated in an exemplary manner. The shop window 102 further includes a frame 108. Multiple image capturing devices 110 are installed along the frame of the shop window according to one implementation. When a potential customer 104 stops by the shop window 102, each of the image capturing devices 110 takes a facial image of the person. The images are taken from different angles towards the person. The images are then transmitted to electronic sub-system 112 of the shop window through a communication means (not shown in the figure). The communication means may be a wired connection and the communication means may also be a wireless connection.

A processor of the electronic sub-system 112 analyzes the received images from each of the image capturing devices and determines the person's facial orientation towards one of the displayed items. Advertising messages are transmitted from the electronic sub-system 112 to a mobile communication device 114 carried by the potential customer 104 through a communication link 116. The advertising messages may be closely related to the displayed item that the person is oriented towards.

FIG. 1B is a schematic diagram illustrating an advertising message delivery system 101 according to another embodiment. Each displayed item is associated with an image capturing device 110. When a potential customer 104 stops by the window, each of the image capturing devices 110 takes a facial image of the person. According to one implementation, each image capture device may be orientated towards front side of the window. Although one image capturing device is illustrated for each displayed item, more than one device may be installed in association with each item. The images are transmitted to the electronic sub-system 112. A processor of the electronic sub-system 112 analyzes the received images from each of the image capturing devices and determines the person's facial orientation towards one of the displayed items. Advertising messages are transmitted from the electronic sub-system 112 to a mobile communication device 114 through a communication link 116. The advertising messages may be closely related to the displayed item the person is oriented towards.

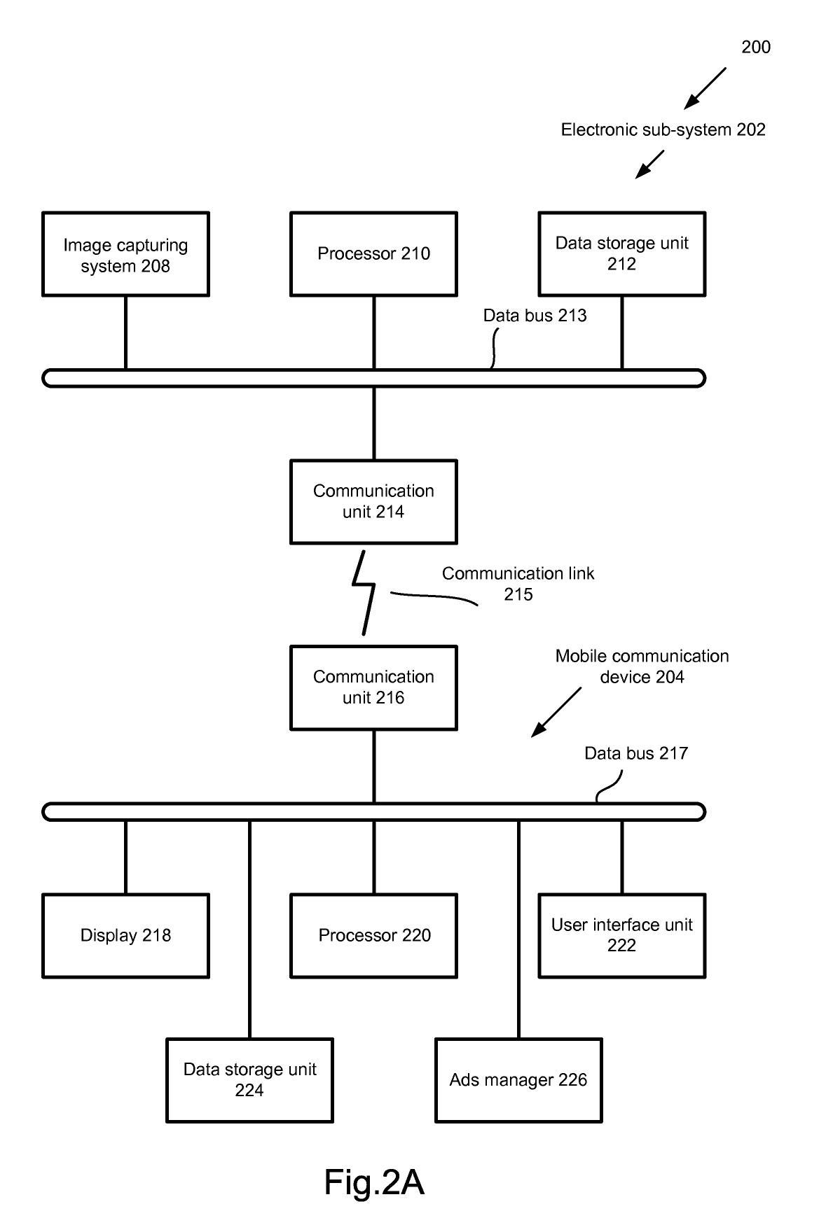

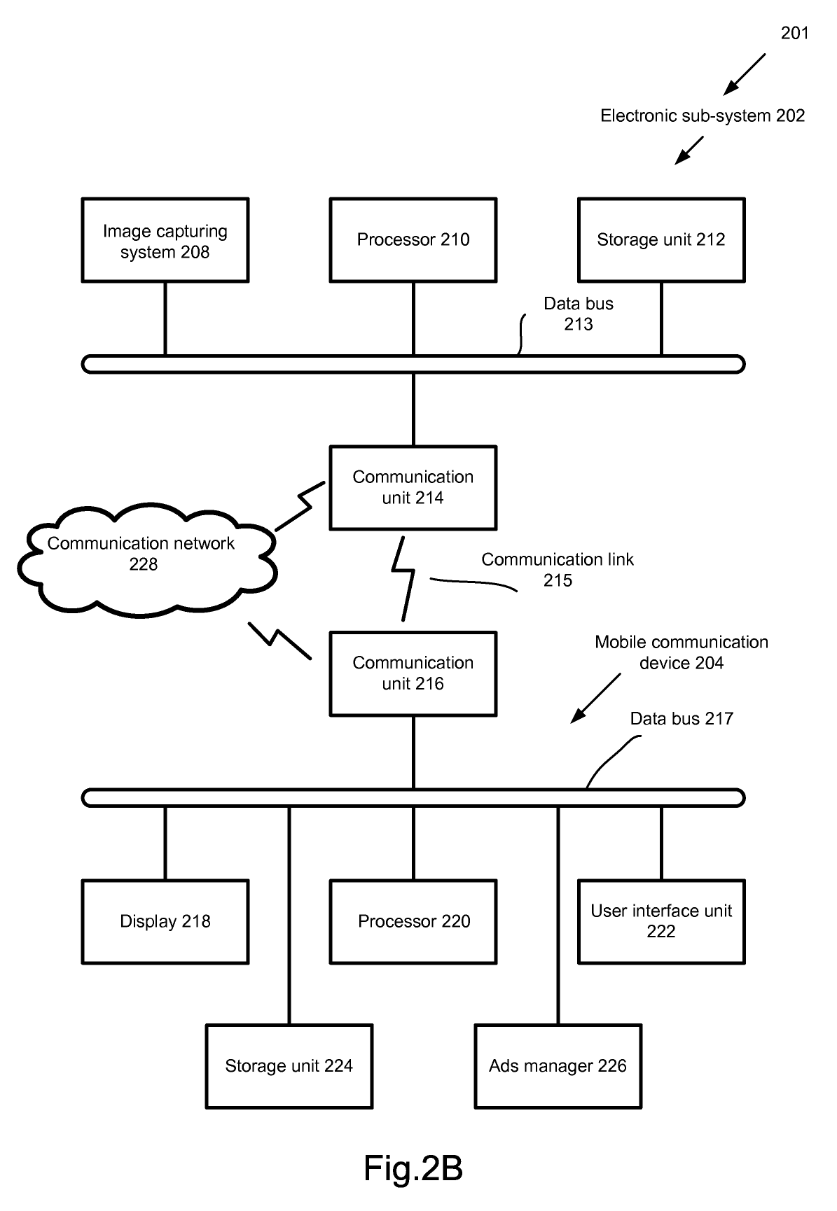

FIG. 2A is a schematic diagram of functional blocks of an exemplary advertising message delivery system 200. The system 200 comprises an electronic sub-system 202 installed in the shop window in an exemplary implementation. The electronic sub-system 202 may also be installed in any location in the proximity of the shop window. The system 200 further comprises a mobile communication device 204 carried by the potential customer. The electronic sub-system 202 further comprises an image capturing system 208. According to one implementation, system 208 further includes multiple image capturing devices. In an exemplary case, the image capturing devices are digital cameras. The image capturing system 208 is used to determine the potential customer's facial orientation towards one of the displayed items.

The electronic sub-system 202 further comprises a processor 210. The processor 210 may include more than one processor. The processor 210 may further include a microprocessor and a digital signal processor. The captured images of the potential customer are sent to the processor 210 for further analyzing to determine the person's facial orientation. Determining a person's facial orientation by multiple digital cameras is known in the art. The electronic sub-system 202 further includes a data storage unit 212 for storing system data and for storing advertising messages related to displayed items. The advertising messages may include but not limited to product identifier, pricing, features, reliability data, customer rating and consumable guidelines. The functional blocks are connected through a conventional data bus 213. The image capturing system 208 may also be connected to the processor 210 through a wireless communication network.

A communication unit 214 is used in the electronic sub-system 202 to send data to and to receive data from the mobile device 204. The communication unit 214 may include a transceiver. According to one implementation of the present invention, the communication unit 214 of the electronic sub-system 202 and the communication unit 216 of the mobile device 204 forms an ad hoc communication link. The ad hoc communication link 215 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC).

The communication units 214 and 216 may further include a network interface for connecting to public communication network including a public phone network and the Internet.

The mobile communication device 204 further comprises a display unit 218 pertaining to be a Liquid Crystal Display (LCD) according to one implementation. The mobile communication device 204 may also include a processor 220 and a user interface unit 222. The processor 220 may include multiple processors including general purpose and special purpose processors. The user interface unit 222 may include user input structures such as buttons and touch-pads. The user interface unit 222 may further include input devices that translate the user input actions into signals for the processor 220. The mobile device 204 further includes a data storage unit 224. The received advertising messages may be stored in the data storage unit 224 for reviewing in a late stage. An advertisement manager 226 is used to control the device operation related to receiving the advertising messages. All function blocks for the mobile device 204 are connected through a data bus 217.

FIG. 2B is a schematic diagram of functional blocks of the advertising message delivery system 201 according to another embodiment of the present invention. The communication unit 214 of the electronic sub-system 202 and the communication unit 216 of the mobile communication device 204 are connectable through an ad hoc communication link 215 as described previously. Additionally, the communication units 214 and 216 are also connectable to a public communication network 228 such as, for example, the Internet or a public phone network. After the communication units 214 and 216 are connected in an ad hoc manner, a communication address of the mobile communication device 204 may be sent to the electronic sub-system 202. After receiving the address, the advertising messages may be transmitted to the mobile device 204 via the communication network 228. The communication address may be a phone number. The communication address may also be an e-mail address.

By connecting to a public communication network 228, a server (not shown in the figure) operated by an operator may be connected to advertisers to deliver the most updated advertising messages to the mobile device 204.

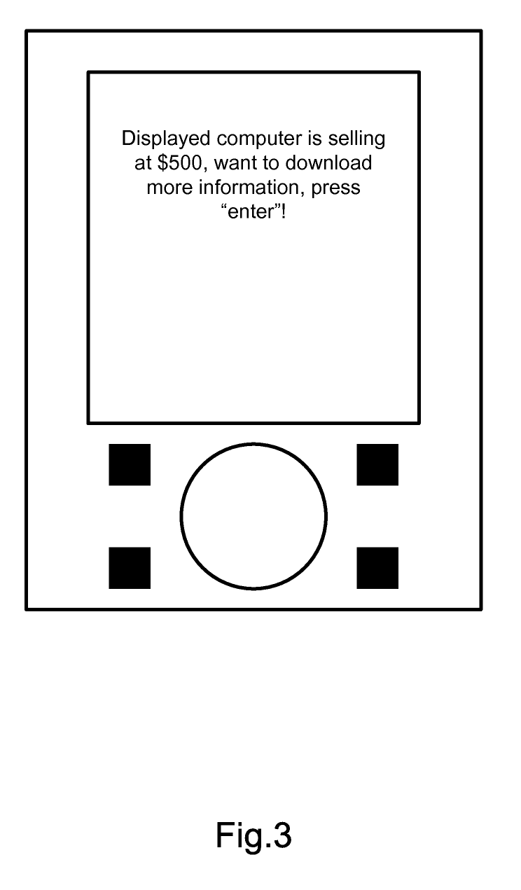

FIG. 3 is a schematic diagram illustrating a received message from the electronic sub-system 202 is displayed on a display screen of the mobile communication device 204. An alerting message may be delivered. The alerting message may be a beep, a ring tone or a vibration. The person may react to the displayed message by a user input action to accept or to deny receiving the message. The person may also send a communication address of the mobile communication device 204 by reacting to the displayed message.

The advertising messages may be delivered as a text message, as an image, as a Short Message Service (SMS), as an e-mail, as a voice message and as a multimedia file.

The advertising messages may be delivered to an idle screen of the mobile device 204. The advertising messages may also be delivered as an icon on the display screen of the mobile device 204. The messages may be delivered including a product identifier. By selecting to view the receive message in details, the mobile device 204 may be connected to a server through the Internet. The person may be able to access a web page including more detailed product information including but not limited to product pricing, features, reliability data, customer rating and consumer guidelines. Furthermore, price for the product from different retailers may be displayed for the user's selection. The detailed product information may be presented to the person in a hierarchical manner as known in the art.

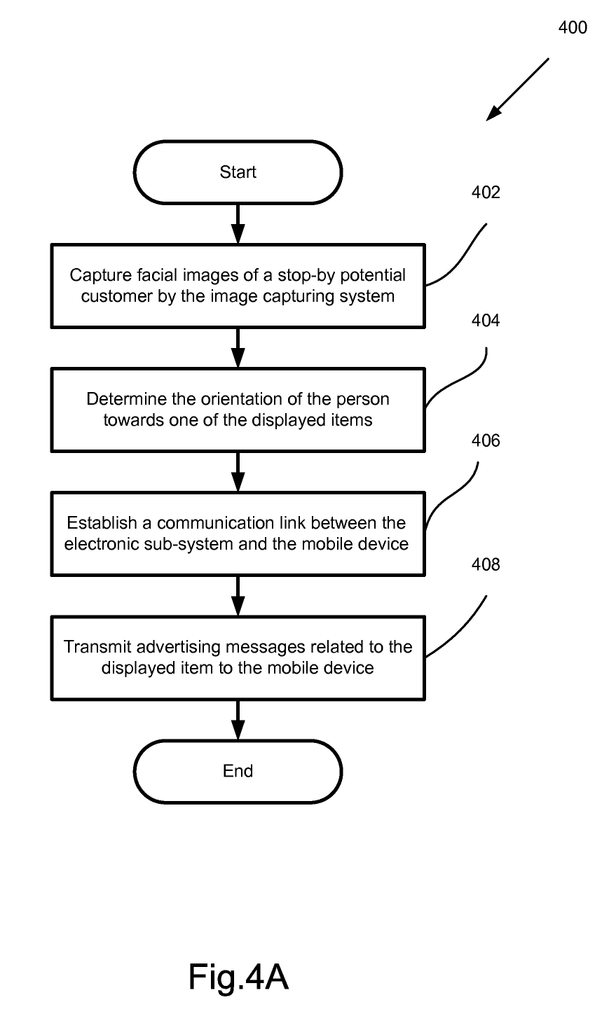

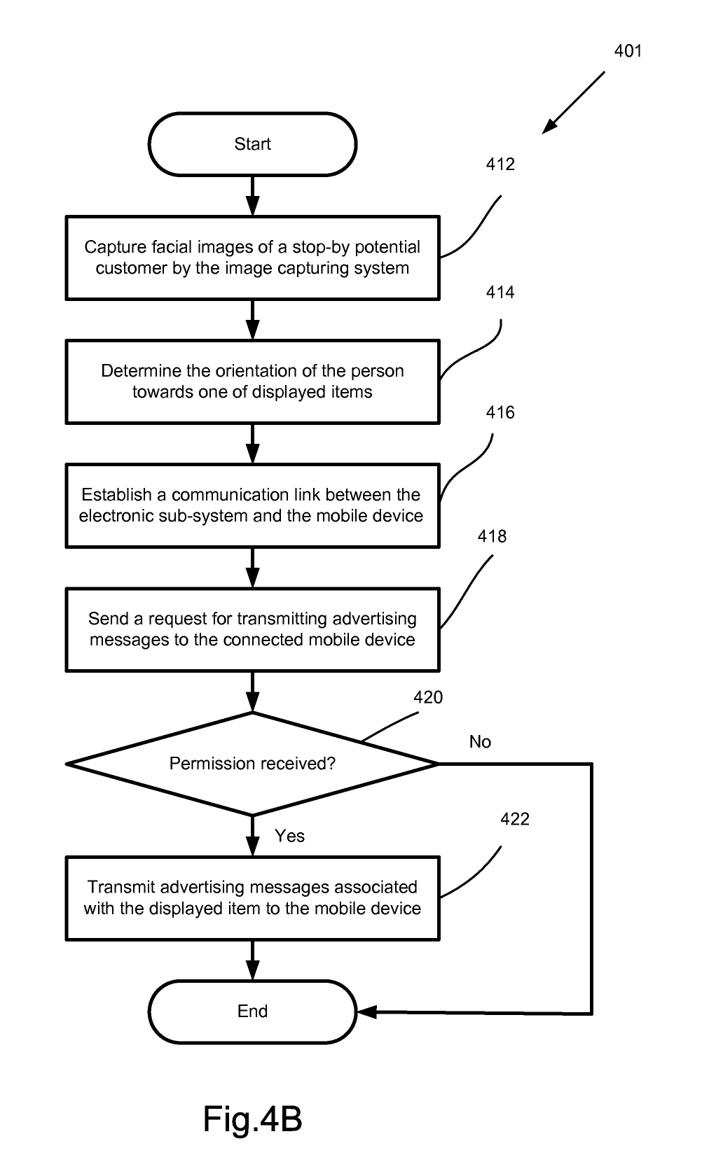

FIG. 4A is a flowchart illustrating a process for the embodiment illustrated in FIG. 2A that an advertising message is delivered from the electronic sub-system 202 in the shop window to the mobile communication device 204. Process 400 starts with step 402 that a potential customer stops by a shop window and his or her facial images are taken by the image capturing system 208. According to one implementation of the present invention, the image capturing devices are digital cameras. The cameras may be arranged along the frame of the window. The cameras may also be placed on or near each of the displayed items. The collected images are sent to the processor 210 of the electronic sub-system 202. The facial orientation of the person towards one of the displayed items is determined in step 404. If the person stays in the proximity of the window shop in exceeding of a predetermined period of time, an ad hoc communication link 215 is established between the electronic sub-system 202 and the mobile communication device 204 in step 406. The ad hoc communication link 215 may be conformed to one of various IEEE or ISO standards and their extensions such as, for example, IEEE 802.15.1 (Bluetooth), IEEE 802.15.4 (ZigBee), IEEE 802.11x (WiFi) and ISO 18092 and ISO 21481 (NFC). The advertising messages are transmitted from the electronic sub-system 202 to the mobile communication device 204 in step 408. The messages may be closely related to the item the person orientated towards.

FIG. 4B is a flowchart illustrating a process for the embodiment illustrated in FIG. 2A with a different implementation. Process 401 starts with step 412 that a potential customer stops by a shop window and his or her facial images are taken by the image capturing system 208. The collected images are sent to the processor 210 of the electronic sub-system 202. The facial orientation of the person towards one of the displayed items is determined in step 414. If the person stays in the proximity of the window shop in exceeding of a predetermined period of time, an ad hoc communication link 215 is established between the electronic sub-system 202 and the mobile communication device 204 in step 416. The ad hoc communication link 215 may be conformed to one of various IEEE or ISO standards as described previously. A request for sending advertising message is then sent to the mobile device 204 in step 418. The person by reviewing the incoming message displayed on a display screen 218 of the mobile device 204 may trigger an operation of sending back a confirmation signal to the electronic sub-system 202. In step 420, if the permission from the person is received by 202, the advertising messages are transmitted to the mobile communication device 204 in step 422. Otherwise, the operation is aborted and the displayed message is erased.

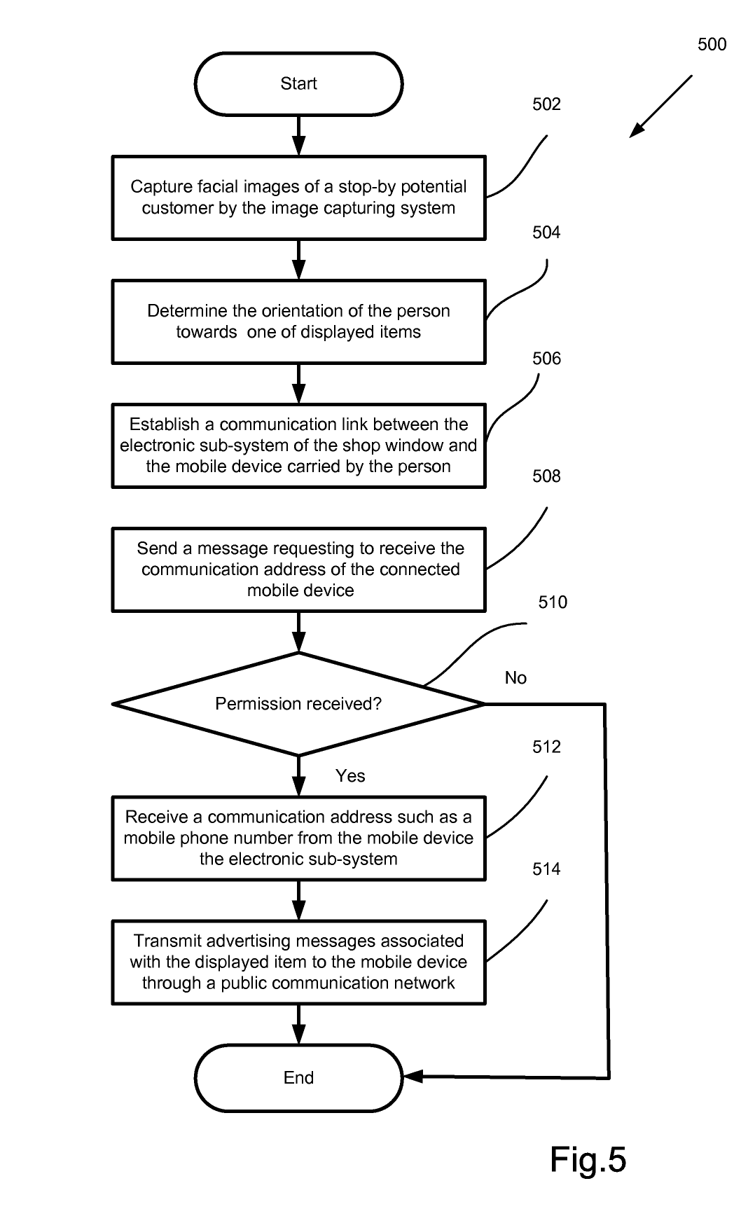

FIG. 5 is a flowchart illustrating the advertising message delivery process according to the embodiment illustrated in FIG. 2B that the communication units of the electronic sub-system 202 and the mobile communication devices 204 are both connectable to a public communication network 228. Process 500 starts with step 502 that a potential customer stops by a shop window and his or her facial images are taken by the image capturing system 208. The collected images are sent to the processor 210 of the electronic sub-system 202. The facial orientation of the person towards one of the displayed items is determined in step 504. If the person stays in the proximity of the shop in exceeding of a predetermined period of time, an ad hoc communication link 215 is established between the electronic sub-system 202 and the mobile communication device 204 in step 506. A request is then sent from the electronic sub-system 202 to the mobile device 204 in step 508 for receiving a communication address of the mobile device 204. The received message is displayed on a display screen 218 of the mobile device 204. An alerting signal may be delivered to attract the person's attention for the arrival of such a message. In step 510, the processor 210 of the electronic sub-system 202 checks if such a permission from the person is received. If the result is positive, the communication address such as a phone number and/or an e-mail address are received in step 512 and the advertising messages are transmitted to the mobile device in step 514 through the public communication network 228. Otherwise the operation is aborted and the process 500 is completed.

One of the benefits of using a public communication network is that transmission of data is more reliable. Furthermore, an advertising server may be connected through the network and the latest advertising messages may be delivered. The server may be connected to advisers, to retailers and to manufacturers.

In an exemplary implementation, the communication unit 216 of the mobile communication device 204 may include a NFC with one or more communication addresses stored in a RFID tag. When the potential customer stops by the shop window, a reader in the window reads out the stored address from the RFID tag with the person's permission and sends the received data to the processor 210. The advertising messages are then transmitted from the electronic sub-system 202 to the mobile communication device 204 in step 514 through the public communication network 228.

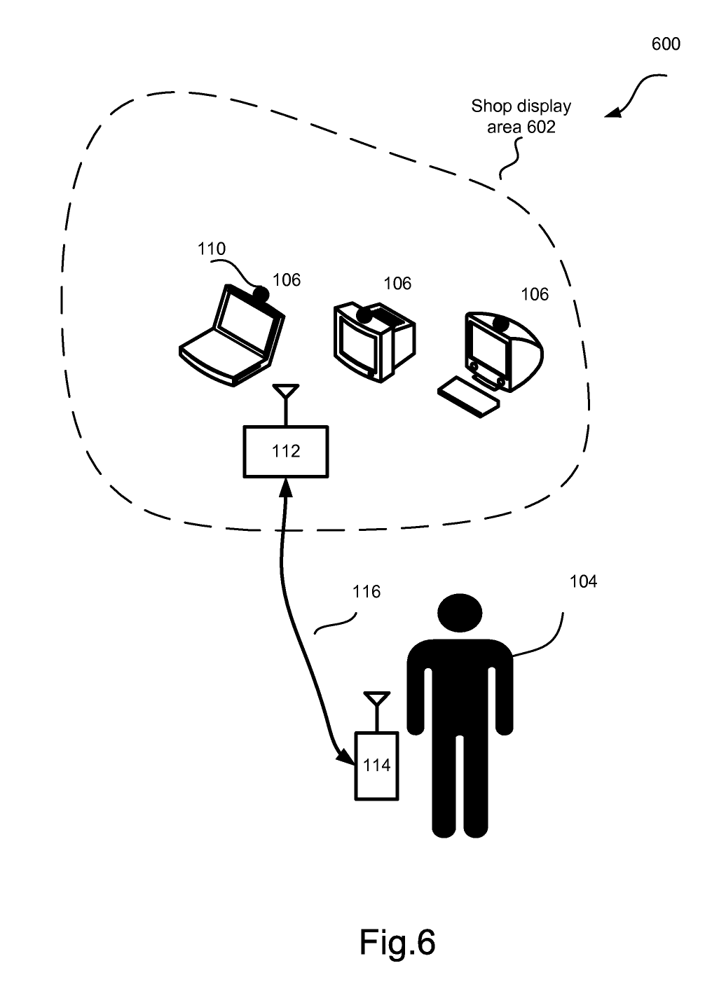

FIG. 6 is a schematic diagram illustrating an extension of the present inventive concept to a generic display area in a shop. Multiple commercial items 106 are displayed in a shop display area 602. Each displayed item is associated with one or more digital camera 110. A potential customer stops by the area 602. Facial images of the person are taken by the digital cameras. If the person stays in front of a displayed item in exceeding of a predetermined period of time, the person is classified as to be interested in the item. A communication link 116 is established and advertising messages may be transmitted to the mobile device 114 either through the ad hoc communication link 116 or through a public communication network after receiving the communication address of the mobile device 114 in a similar manner described previously.

While the invention has been disclosed with respect to a limited number of embodiments, numerous modifications and variations will be appreciated by those skilled in the art. It is intended that all such variations and modifications fall with in the scope of the following claims:

1. An advertising message delivery system comprising:
a display area with at least one displayed commercial item;
an image capturing system including a plurality of image capturing devices for capturing a plurality of facial images of a stop-by potential customer;
a processor for processing the captured facial images and for determining facial orientation of the potential customer towards at least one of the displayed items; and
a communication unit for delivering advertising messages related to the displayed item to a mobile communication device of the potential customer through a communication means.

2. The system as recited in claim 1, wherein said display area including a shop window and said image capturing devices may be installed in predetermined positions along a frame of the shop window.

3. The system as recited in claim 1, wherein said image capturing devices may be installed in predetermined positions associated with displayed items.

4. The system as recited in claim 1, wherein said image capturing devices further including digital cameras.

5. The system as recited in claim 1, wherein said image capturing system further including a connection means for connecting to the processor.

6. The system as recited in claim 1, wherein said communication means further comprising a pair of communication units with one located in the display area and another located in the mobile communication device.

7. The system as recited in claim 1, wherein said communication means conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

8. The system as recited in claim 1, wherein said communication means further comprising a public communication network including the Internet and/or a public phone network.

9. The system as recited in claim 1, wherein said advertising messages further comprising one or a combination of the following categories of data:
product pricing;
commercial terms;
product features;
product reliability; and
consumer rating.

10. A method of delivering an advertising message from a shop window to a mobile device carried by a person comprising:
capturing a plurality of facial images of the person stopping by the shop window by an image capturing system;
analyzing the captured images and determining the facial orientation of the person towards at least one of displayed items by a processor;
establishing a communication link between an electronic sub-system of the display area and the mobile device; and
transmitting the advertising message to the mobile device.

11. The method as recited in claim 10, wherein said method further comprising:
delivering an alerting signal by the mobile device; and
receiving the potential customer's selection to receive or to ignore the advertising message.

12. The method as recited in claim 11, wherein said alerting signal including one of or a combination of the following signals:
a ring tone;
a beep; and
a vibration.

13. The method as recited in claim 10, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions);
NFC (ISO 18092; or ISO 21481).

14. The method as recited in claim 10, wherein said image capturing system further comprising a plurality of image capturing devices installed in predetermined positions along a frame of the shop window.

15. The method as recited in claim 10, wherein said image capturing system further comprising a plurality of image capturing devices installed in predetermined positions associated with the displayed items.

16. A method of delivering an advertising message from a shop window to a mobile device carried by a person comprising:
capturing a plurality of facial images of the person stopping by the shop window by an image capturing system;
analyzing the captured images and determining the facial orientation of the person towards at least one of displayed items by a processor;
establishing a communication link between an electronic sub-system of the shop window and the mobile device;
receiving a communication address of the mobile communication device by the electronic sub-system; and
transmitting the advertising message to the mobile device through a public communication network.

17. The method as recited in claim 16, wherein said method further comprising:
displaying a message on a display screen of the mobile device requesting sending a communication address; and
receiving the person's selection to accept or to deny the request.

18. The method as recited in claim 16, wherein said communication address of the mobile device further including a mobile phone number and/or an e-mail address.

19. The method as recited in claim 16, wherein said advertising message may be delivered in one of or a combination of the following means:
a. Short Message Service (SMS);
b. an e-mail;
c. a message displayed on an idle screen of the mobile device; and
d. a phone call.

20. The method as recited in claim 16, wherein said image capturing system further comprising a plurality of digital cameras installed in predetermined positions along a frame of the shop window or installed in predetermined positions associated with the displayed items.
